(19) United States
(12) Patent Application Publication
(10) Pub. No.: US 2009/0115405 A1
(43) Pub. Date: May 7, 2009

(54) Magnetic field angular sensor with a full angle detection

(75) Inventors: Yimin Guo, San Jose, CA (US); Grace Gorman, San Jose, CA (US)

Correspondence Address: SAILE ACKERMAN LLC, 28 DAVIS AVENUE, POUGHKEEPSIE, NY, 12603, US

(73) Assignee: MagIC Technologies, Inc.

(21) Appl. No.: 11/982,188

(22) Filed: Nov. 1, 2007

(51) Int. Cl. G01B 7/30; B05D 5/12

(52) U.S. Cl. 324/207.14; 427/131; 427/598

(57) ABSTRACT

An integrated angular magnetic sensor apparatus for determining a magnetic field angle within two axes of a plane is formed on a substrate onto which two anisotropic magneto-resistive sensing elements and at least one magneto-resistive sensing element are fabricated. The two anisotropic magneto-resistive sensing elements are oriented such that the output voltages of a first and second of the anisotropic magneto-resistive sensing elements are a function of a first and second trigonometric function (a sine function) of the magnetic field angle to a reference axis. The at least one magneto-resistive sensing element on the substrate and having a fixed reference magnetization oriented with respect to the reference axis such that an output voltage of the at least one magneto-resistive sensing element provides a quadrant indicator for the magnetic field angle with respect to the reference axis. The quadrant indicator is a trigonometric function such as a sine or cosine function.

### RELATED PATENT APPLICATIONS

“A Magnetic Tunnel Junction (MTJ) Based Magnetic Field Angle Sensor”, Ser. No. 11/799,706, Filing Date May 2, 2007, assigned to the same assignee as this invention and incorporated herein by reference.

### BACKGROUND OF THE INVENTION

1. Field of the Invention

This invention relates generally to magneto-resistive sensor devices for detecting a magnetic field impinging upon the magneto-resistive sensor device. More particularly, this invention relates to magnetic field angle sensors for measurement of a magnetic field angle over a 360° range of measurement of a plane.

2. Description of Related Art

Magnetic position sensing is becoming a popular method of implementing a non-contacting location of objects in motion. By affixing a magnet or sensor element to an angular or linear moving object with its complementary sensor or magnet stationary, the relative direction of the resulting magnetic field can be quantified electronically. By utilizing multiple sensors or magnets, the capability of extended angular or linear position measurements can be enhanced. “Applications of Magnetic Position Sensors”, Honeywell Application Note-AN211, found www.ssec.honeywell.com/magnetic/datasheets/an211.pdf, Mar. 20, 2007 describes magnetic position sensing using Anisotropic Magneto-Resistive (AMR) sensors.

Further, AN211 describes the use of an anisotropic magneto-resistive material such as Permalloy to form four anisotropic magneto-resistive (AMR) elements 10a, 10b, 10c, and 10d that are connected as a Wheatstone bridge sensor 5, as shown in FIG. 1. Each magneto-resistive element 10a, 10b, 10c, and 10d possesses an ability to change resistance in a cos²(θ) relationship where θ (theta) is the angle between the magnetic moment (M) vector 25a, 25d, 25c, and 25d and the current flow (I) 20a, 20d, 20c, and 20d.

The sensor is formed from the AMR elements 10a, 10b, 10c, and 10d, the four elements 10a, 10b, 10c, and 10d are oriented in a diamond shape with the ends connected together by metallization 12a, 12b, 12c, and 12d to form the Wheatstone bridge. The top and bottom connections of the four identical elements are connected Direct Current (DC) power supply voltage source (Vₛ) 15. The remaining two opposing side connection terminals 12cand 12d are the sense point of the measurement. With no magnetic field supplied (0 gauss), the side connection terminals 12cand 12d have an equal voltage level with the exception of a small offset voltage due to manufacturing tolerances on the AMR elements 10a, 10b, 10c, and 10d. The Wheatstone bridge connection structure 5 produces a differential voltage (ΔV) as a function of the supply voltage Vₛ. The ratio of the resistance of the AMR elements 10a, 10b, 10c, and 10d, and the angle (θ) between the element current flow (I) 20a, 20d, 20c, and 20d and element magnetization (M) 25a, 25d, 25c, and 25d

The AMR Wheatstone bridge 5 as constructed provides an angle measurement of ±45°. To provide measurement of from ±45° to ±90° requires two AMR Wheatstone sensors with 45° displacement from each other, the two linear slopes can be used additively.

FIG. 2 shows a full 360° rotational position sensing solution that uses two of the AMR Wheatstone bridge sensors 100 combined with a Hall Effect sensor 105. A motor 110 rotates a shaft 115 in a designated direction 116. A magnet 120 is placed at the end of the shaft 115 and is rotated with the shaft 115. The magnetic flux 125 from the magnet 120 exits the north pole (N) of the magnet 120 and returns to the south pole (S) of the magnet 120. The AMR Wheatstone bridge sensors 100 is placed on the shaft axis, just above the magnet, the magnetic flux 125 passing through the AMR sensor bridges 100 will retain the orientation of the magnet 120. From this rotation, the output of the two AMR Wheatstone bridge sensors 100 will create sine 135 and cosine 140 waveforms of FIG. 3.

A Hall Effect sensor 105 is similarly is placed on the shaft axis 130, just above the magnet 120, the magnetic flux 125 passing through the Hall Effect sensor 105 will similarly retain the orientation of the magnet 120. Most Hall Effect sensors use silicon semiconductor materials to create a proportional voltage output as a magnetic field vector 125 slices orthogonally through the slab material with a bias current flowing through it to generate a signed vector waveform 145 of FIG. 3 of the impinging magnetic field.

The sine 135 and cosine 140 waveforms from the AMR Wheatstone bridge sensors 100 and the signed vector waveform 145 from the Hall Effect sensor 105 are the input of the motor control unit. The characteristic of AMR effect of the AMR Wheatstone bridge sensors 100 is such that the resistance change is a function of cos²(θ), where θ is the angle between the magnetization and current flowing direction. As described above, one of the AMR Wheatstone bridge sensors 100 only detects 90-degree angle and two AMR Wheatstone bridge sensors 100 with 45-degrees orientation difference only allow a measurement of 180-degree angle. The signal output voltage 135 of the first of the AMR Wheatstone bridge sensors 100 is Va=Vs/2 dR/R sin(2θ), while signal output voltage 140 of the second of the AMR Wheatstone bridge sensors 100, which is orientated 45° differently from the first of the AMR Wheatstone bridge sensors 100, is Vb=Vs/2 dR/R cos(2θ). The magneto-resistive ratio of AMR film is dR/R. In another words, the measured angle is either the real magnetic field angle θ or its opposite direction θ+180°. In order to measure a full 360-degree angle, The signal output voltage of the Hall Effect sensor 105 provides the signal output voltage 145. The sign value of the signal output voltage 145 provides the indication of the quadrant that the magnetic field vector 125 is occupying. The motor controller calculates the angle θ as the arctangent function of the sine 135 and cosine 140 waveforms from the AMR Wheatstone bridge sensors 100 and with quadrant being determined by the signed vector waveform 145 from the Hall Effect sensor 105.

In order to achieve a full angle rotational sensor of high accuracy, one has to mechanically adjust the Hall Effect sensor 105 to ensure that the Hall Effect sensor 105 is nearly perfectly orientated with respect to the two AMR Wheatstone bridge sensors 100 so that the arctangent equation deriving the angle of the magnetic flux 125 arrives at the end positions just as the Hall Effect sensor 105 output achieves a zero volt output. This critical alignment is difficult to achieve and thus time consuming and costly.

“Angular Sensor Using Tunneling Magneto-resistive Junctions with an Artificial Antiferromagnet Reference Electrode and Improved Thermal Stability”, Ruhrig, et al., IEEE Transactions on Magnetics, January 2004 Volume: 40, Issue: 1, pp.: 101-104, describes fabrication of Magnetic tunneling junctions (MTJs) using CoFe—Ru—CoFe artificial antiferromagnet (AAF) sandwiches as a hard-magnetic reference layer and plasma-oxidized aluminum as a tunnel barrier. Tailoring the magnetic properties of the artificial antiferromagnet reference layer allows an on-chip magnetization (initialization) of individual junctions, which makes it possible to build monolithic Wheatstone without multiple mask process steps or on-chip heating elements.

“Exchange Anisotropy and Micromagnetic Properties of PtMn/NiFe Bilayers”, Pokhil, et al., Journal of Applied Physics, Jun. 1, 2001, Vol.: 89, Issue: 11, pp.: 6588-6590, describes the study of magnetic microstructure, exchange induced uniaxial and unidirectional anisotropy and structural transformation have in PtMn/NiFe bilayer films and small elements as a function of annealing time.

U.S. Pat. No. 7,054,114 (Jander, et al.) provides a ferromagnetic thin-film based magnetic field sensor with first and second sensitive direction sensing structures. The direction sensing structures each have a nonmagnetic intermediate layer with two major surfaces on opposite sides thereof having a magnetization reference layer on one and an anisotropic ferromagnetic material sensing layer on the other. The direction sensing structures have a length and a smaller width. The width is placed parallel to the relatively fixed magnetization direction. The relatively fixed magnetization direction of the magnetization reference layer in the direction sensing structures is oriented substantially parallel to the substrate but substantially perpendicular to that of the other direction sensing structures. An annealing process is used to form the desired magnetization directions.

“360° Angle Sensor Using Spin Valve Materials with SAF Structure’, Wang et al., IEEE Transactions on Magnetics, October 2005, Vol.: 41, Issue: 10, describes the design, fabrication, and test of microchips of 360° angle sensors using spin valve materials. A special Wheatstone-bridge with four spin valve resistors is used to compensate the thermal drift expected in application environments. One half bridge has a 90° phase delay from the other, resulting in a cosine and a sine function, in combination to uniquely determine any angular relationship between the permanent magnet and the sensor between 0 to 360°.

U.S. Pat. No. 5,796,249 (Andra, et al.) provides a magnetoresistive angular position sensor and rotation speed sensor that includes a permanent magnet rotatable about an axis of rotation and at least three Wheatstone bridges formed of magnetoresistive strip lines extending in planes parallel to a rotation plane of the permanent magnet.

U.S. Pat. No. 6,100,686 (Van Delden, et al.) teaches a magnetic field sensor with double Wheatstone bridges having magneto-resistive elements. The two bridges are identical except in that, if a given magneto-resistive element in a given branch in one bridge has a positive output polarity, then the corresponding magneto-resistive element in the same branch in the other bridge will have a negative output polarity. By adding the output signals of the two Wheatstone bridges a zero-point offset of the sensor can be determined and eliminated.

U.S. Pat. No. 6,633,462 (Adelerhof) describes a magnetoresistive angular sensor which determines a magnetic field direction. The magnetoresistive angular sensor has a main sensing element which is electrically connected to a two correction sensing elements, each with a reference magnetization axis. The reference magnetization axes make correction angles θ between 5° and 85° of opposite sign with the main reference axis.

U.S. Patent Application 2005/0140363 (Grimm, et al.) provides a magnetic sensor for detection of the orientation of a magnetic field. The magnetic sensor has at least two magnetoresistive elements that are non-parallel to provide determination of the direction of a magnetic field.

U.S. Patent Application 2006/0103381 (Schmollngruber, et al.) teaches a GMR sensor element having a rotationally symmetrical positioning of eight GMR resistor elements which are connected to each other to form two Wheatstone full bridges. This GMR sensor element is especially suitable for use in an angle sensor for the detection of the absolute position of the camshaft or the crankshaft in a motor vehicle.

U.S. Patent Application 2007/0035294 (Peczalski, et al.) describes an integrated Three-Dimensional Magnetic Sensing Device. The integrated three-dimensional magnetic device has a substrate with a surface area oriented to the top surface of the substrate and at least one sloped surface which is sloped with respect to the surface area parallel with the top surface of the substrate. Two magnetic sensing units are arranged on the top surface area to provide first and second orthogonal sensing directions, and a third magnetic sensing unit could be arranged on the sloped surface to provide sensing in at least a third sensing direction which is orthogonal to the first and second orthogonal sensing directions.

U.S. Patent Application 2007/0080683 (Bartos, et al.) illustrates a magnetoresistive sensor for determining an angle or a position. The magnetoresistive sensors use the AMR or the GMR effect and indicate the direction of the homogeneous magnetic field of a rotatable permanent magnet in the angle measurement or the position of the sensor with respect to a scale. The scale is magnetized periodically in an alternating direction, for the position measurement, and in which the angle or position value is obtained from the quotient of the output signals from two bridges or half bridges with the aid of arctan interpolation. This allows small measurement errors if the output signals have small harmonic components and hysteresis areas.

### SUMMARY OF THE INVENTION

An object of this invention is to provide an integrated angular magnetic sensor apparatus for determining a magnetic field angle within two axes of a plane.

To accomplish at least this object, an integrated angular magnetic sensor apparatus has a substrate onto which two anisotropic magneto-resistive sensing elements and at least one magneto-resistive sensing element is fabricated. The two anisotropic magneto-resistive sensing elements are oriented with respect to each other such that an output voltage of a first of the anisotropic magneto-resistive sensing elements is a function of a first trigonometric function (a sine function) of the magnetic field angle to a reference axis and an output voltage of a second of the anisotropic magneto-resistive sensing elements is a function of a second trigonometric function (cosine function) of the magnetic field angle to the reference axis. The at least one magneto-resistive sensing element on the substrate and oriented with respect to the reference axis such that an output voltage of the at least one magneto-resistive sensing element provides a quadrant indicator for the magnetic field angle with respect to the reference axis. The quadrant indicator is a trigonometric function such as a sine or cosine function.

The integrated angular magnetic sensor apparatus has a magnetic field angle calculator connected to receive the output voltages of the two anisotropic magneto-resistive sensing elements and the output voltage of the at least one magneto-resistive sensing elements. The integrated angular magnetic sensor apparatus determine the magnetic field angle from the output voltages of the two anisotropic magneto-resistive sensing elements and the at least one magneto-resistive sensing element.

The each of the two anisotropic magneto-resistive sensing elements includes four anisotropic magneto-resistive material structures formed on the substrate and connected to form a Wheatstone bridge. One Wheatstone bridge of the two anisotropic magneto-resistive sensing elements is rotated by an orientation angle such that the second trigonometric function is the first trigonometric function shifted by the orientation angle. Each of the four anisotropic magneto-resistive material structures formed on the substrate is formed of a dielectric layer formed on the substrate. A seed layer is then deposited upon the dielectric layer; and a ferromagnetic film dielectric layer deposited on the dielectric layer. The seed layer is NiFeCr, NiCr, Ta, or an equivalent alloy. The ferromagnetic layer is a binary alloy or a ternary alloy of Ni, Fe, Co, or equivalent ferromagnetic materials.

The at least one magneto-resistive sensing element is either a giant-magneto-resistive structure or a magnetic tunnel junction structure. If the at least one magneto-resistive sensing element is a giant-magneto-resistive structure formed on the substrate, the at least one magneto-resistive sensing element includes a dielectric layer formed upon the substrate. An anti-ferromagnetic layer is then deposited upon the dielectric layer and a synthetic pinned layer is deposited upon the anti-ferromagnetic layer. A nonmagnetic conductive layer is deposited upon the synthetic pinned layer and a free layer is then deposited upon the conductive layer.

The anti-ferromagnetic layer is formed of binary alloys or tertiary alloys of Pt, Mn, Pd, or equivalent anti-ferromagnetic materials. The synthetic pinned layer has a first anti-parallel structure deposited upon the anti-ferromagnetic layer. A nonmagnetic space layer is then deposited upon the first anti-parallel structure with a second anti-parallel structure deposited upon the nonmagnetic space layer. The first and second anti-parallel structures are a binary alloys or ternary alloys of Ni, Fe, Co, B or equivalent ferromagnetic materials. The non-magnetic space layer is Ru or equivalent nonmagnetic material. The free layer is a binary alloy or ternary allow of Ni, Fe, Co, B, or equivalent ferromagnetic material.

The at least one magneto-resistive sensing element is patterned by a photo-mask into large rectangle-shaped giant-magneto-resistive stripes with a large aspect ratio and different orientations of long axes. The large rectangle-shaped giant-magneto-resistive stripes are then etched to define the at least one magneto-resistive sensing element. Local magnetic fields applied to the at least one magneto-resistive sensing element, which is then thermally annealed to obtain exchange pinning on reference layers with various predetermined directions for each of the giant-magneto-resistive stripes. The local magnetic fields are shape anisotropy fields, stress-induced magnetostrictive anisotropy fields, local hard bias fields, or local flux concentrating fields by adjacent soft magnetic layers.

If the at least one magneto-resistive sensing element is a magnetic tunnel junction structure, at least one magneto-resistive sensing element includes a conductive layer formed upon the substrate as a bottom electrode. An anti-ferromagnetic layer is then deposited upon the conductive layer with a synthetic pinned layer deposited upon the anti-ferromagnetic layer. A tunneling layer is deposited upon the synthetic pinned layer and a free layer deposited upon the tunneling layer, followed by patterning and deposition of a conductive top electrode.

The anti-ferromagnetic layer is a binary alloy or tertiary alloy of Pt, Mn, Pd, or equivalent anti-ferromagnetic materials. The synthetic pinned layer has a first anti-parallel structure deposited upon the anti-ferromagnetic layer with a nonmagnetic space layer deposited upon the first anti-parallel structure. A second anti-parallel structure is then deposited upon the nonmagnetic space layer. The first and second anti-parallel structures are ferromagnetic layers that are formed binary alloys or ternary alloys of Ni, Fe, Co, B or equivalent ferromagnetic materials. The non-magnetic space layer is Ru or equivalent nonmagnetic material. The free layer is a binary alloy or ternary allow of Ni, Fe, Co, B, or equivalent ferromagnetic material.

The at least one magneto-resistive sensing element is patterned by a photo-mask into large rectangle-shaped giant-magneto-resistive stripes with a large aspect ratio and different orientations of long axes. The large rectangle-shaped giant-magneto-resistive stripes are etched to define the at least one magneto-resistive sensing element. Local magnetic fields are applied to the at least one magneto-resistive sensing element, which is then thermally annealed to obtain exchange pinning on reference layers with various predetermined directions for each of the giant-magneto-resistive stripes. The local magnetic fields are shape anisotropy fields, stress-induced magnetostrictive anisotropy fields, local hard bias fields, or local flux concentrating fields by adjacent soft magnetic layers.

The magnetic field angle calculator circuit is connected to provide biasing voltages to the two anisotropic magneto-resistive sensing elements and the at least one magneto-resistive sensing element. The magnetic field angle calculator circuit is connected to receive a first output voltage and a second output voltage from the two anisotropic magneto-resistive sensing elements and at least a third output voltage from the at least one magneto-resistive sensing elements to determine a field angle of a magnetic field impinging upon the angular magnetic sensor.

### BRIEF DESCRIPTION OF THE DRAWINGS

FIG. 1 is a schematic diagram of an anisotropic magneto-resistive sensor of the prior art.

FIG. 2 is a functional block diagram of magnetic field angle detection system incorporating two anisotropic magneto-resistive sensing elements and a Hall Effect sensor of the prior art.

FIG. 3 is a plot of the output voltages of the two anisotropic magneto-resistive sensing elements and a Hall Effect sensor magnetic field angle of the detection system of the prior art.

FIG. 4 is a schematic diagram of a first embodiment of the integrated magnetic field angle detection sensor of this invention.

FIG. 5 is a top plan diagram of the first embodiment of the integrated magnetic field angle detection sensor of this invention.

FIG. 6 is a plot of the output voltages of two anisotropic magneto-resistive sensing elements and a giant-magneto-resistive quadrant sensor of the first embodiment of the integrated magnetic field angle detection sensor of this invention.

FIG. 7 is a block diagram of the first embodiment of the integrated magnetic field angle detection sensor of this invention.

FIG. 8 is a table of the signs of the output voltages of two anisotropic magneto-resistive sensing elements and the magneto-resistive quadrant sensor of the first embodiment of the integrated magnetic field angle detection sensor of this invention.

FIG. 9 is a schematic diagram of a second embodiment of the integrated magnetic field angle detection sensor of this invention.

FIG. 10 is a top plan diagram of the second embodiment of the integrated magnetic field angle detection sensor of this invention.

FIG. 11 is a plot of the output voltages of two anisotropic magneto-resistive sensing elements and two giant-magneto-resistive quadrant sensors of the second embodiment of the integrated magnetic field angle detection sensor of this invention.

FIG. 12 is a block diagram of the second embodiment of the integrated magnetic field angle detection sensor of this invention.

FIG. 13 is a table of the signs of the output voltages of two anisotropic magneto-resistive sensing elements and the two magneto-resistive quadrant sensors of the second embodiment of the integrated magnetic field angle detection sensor of this invention.

FIG. 14 is a cross-sectional view of the integrated magnetic field angle detection sensor of this invention.

FIGS. 15, 16, and 17 are process diagrams for a method of fabrication of the integrated magnetic field angle detection sensor of this invention.

FIG. 18 is a functional block diagram of magnetic field angle detection system incorporating the integrated magnetic field angle detection sensor of this invention.

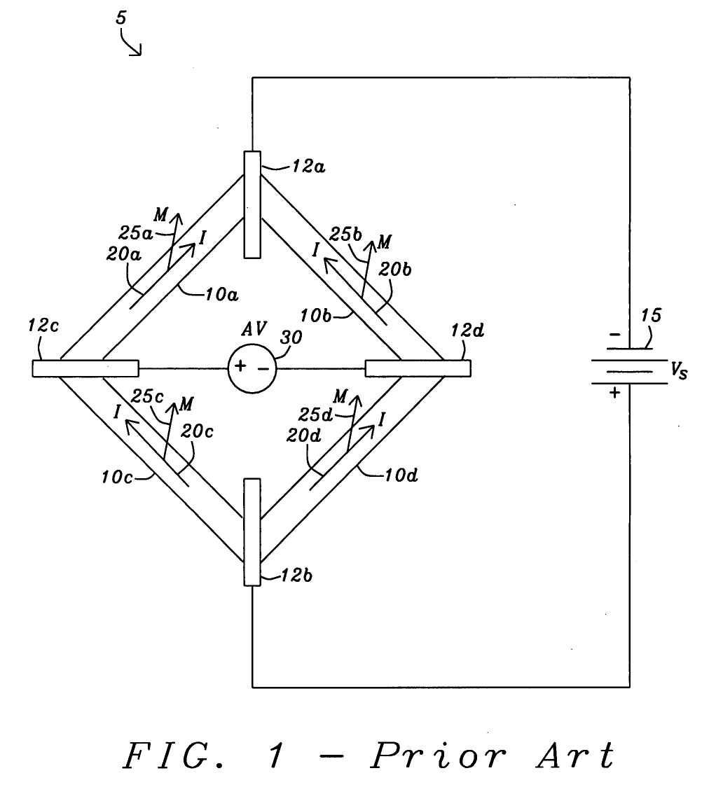

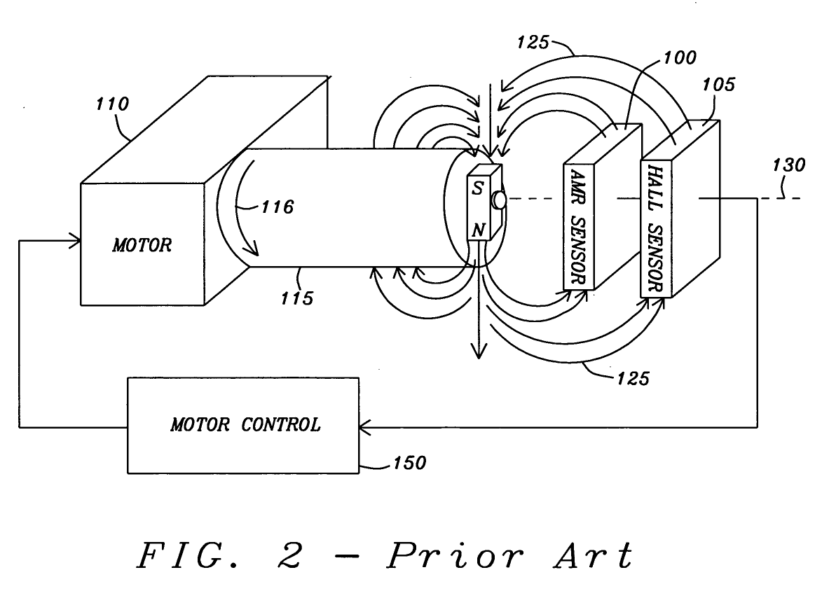

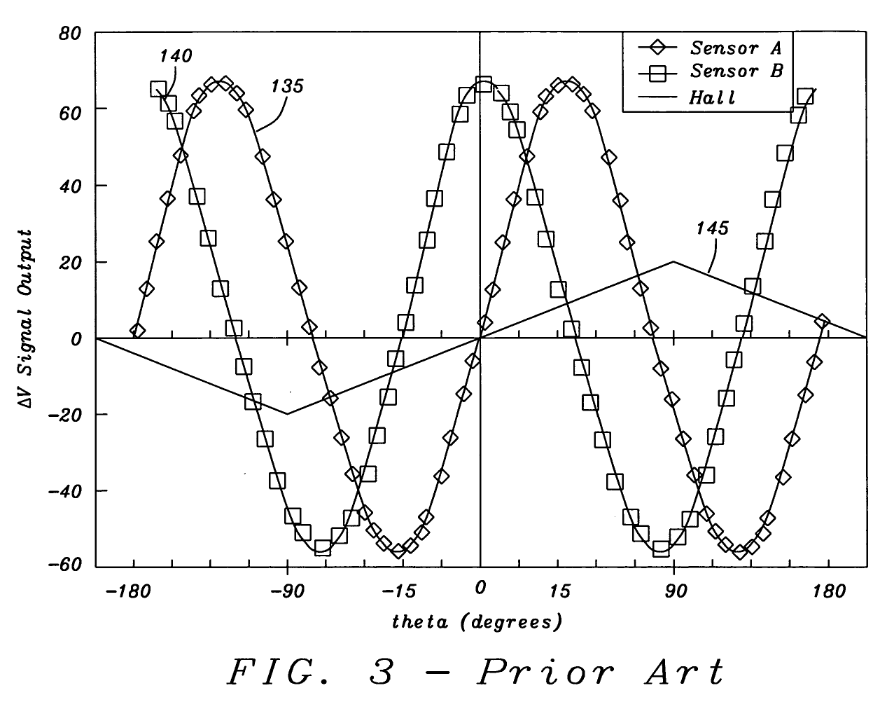

### DETAILED DESCRIPTION OF THE INVENTION

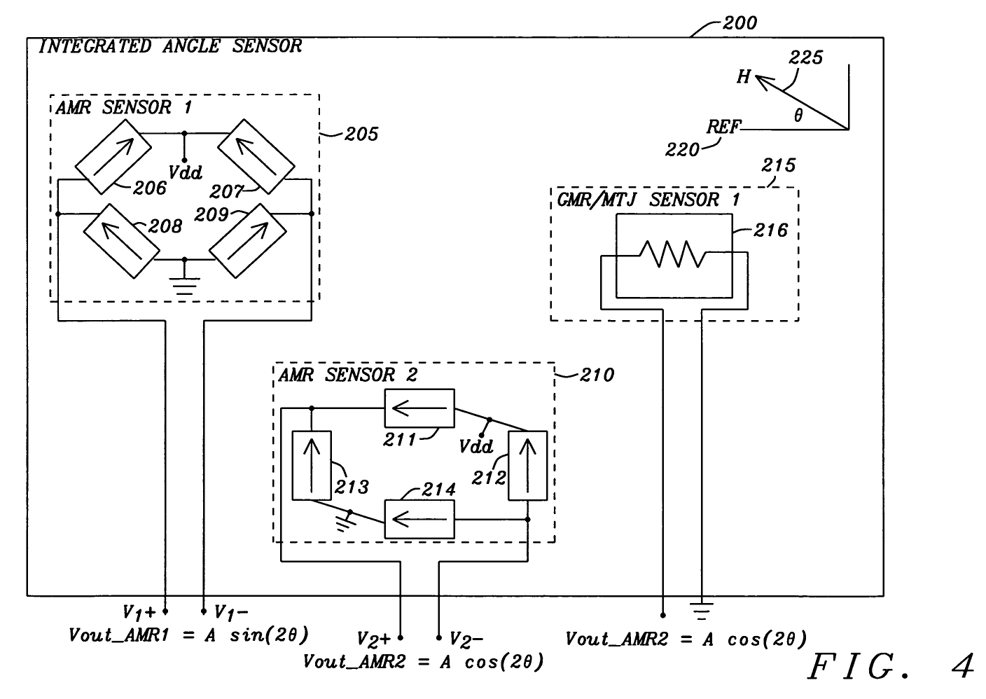

Refer now to FIG. 4 for a description of a first embodiment of an integrated magnetic field angle detection sensor 200 of this invention. The first embodiment of the integrated magnetic field angle detection sensor 200 of this invention includes two anisotropic magneto-resistive sensing elements 205 and 210 and a magneto-resistive quadrant sensor 215. The first of the two anisotropic magneto-resistive sensing elements 205 has four anisotropic magneto-resistive structures 206, 207, 208, and 209 that are connected as a Wheatstone bridge. The four anisotropic magneto-resistive structures 206, 207, 208, and 209 are oriented at an angle to the reference axis of the integrated magnetic field angle detection sensor 200 such that the output voltage Vₒᵤₜ_{_{—}}AMR1 of the first of the anisotropic magneto-resistive sensing element 205 is a function of a first trigonometric function (sine function) of the magnetic field angle (θ) 225 to the reference axis 220. A power supply voltage source V_{dd} is connected to the junctions of the anisotropic magneto-resistive structure 206 and anisotropic magneto-resistive structure 207 and a ground reference point is connected to the junction of the anisotropic magneto-resistive structure 213 and anisotropic magneto-resistive structure 214. The output voltage of the first of the two anisotropic magneto-resistive sensing elements 210 is the differential voltage ((V₁+)−(V₁−)) between the two junctions of the anisotropic magneto-resistive structures 206 and 208 and the anisotropic magneto-resistive structures 207 and 209. The resistance of the four anisotropic magneto-resistive structures 206, 207, 208, and 209 varies according to a first trigonometric function sin(2θ). Thus the output voltage Vₒᵤₜ_{_{—}}AMR1 of the first of the two anisotropic magneto-resistive sensing elements 205 is the function: Vₒᵤₜ_{_{—}}AMR1=V_{dd}/2 dR/R sin(2θ)

The second of the two anisotropic magneto-resistive sensing elements 210 has four anisotropic magneto-resistive structures 211, 212, 213, and 214 that similarly are connected as a Wheatstone bridges. The first two anisotropic magneto-resistive structures 211 and 214 are oriented parallel to the reference axis 220 of the integrated magnetic field angle detection sensor 200. The other two anisotropic magneto-resistive structures 212 and 213, are oriented perpendicular to the reference axis 220 of the integrated magnetic field angle detection sensor 200. A power supply voltage source V_{dd} is connected to the junctions of the anisotropic magneto-resistive structure 211 and anisotropic magneto-resistive structure 212 and the ground reference point is connected to junction of the anisotropic magneto-resistive structures 213 and 214. The output voltage of the second of the two anisotropic magneto-resistive sensing elements 210 is the differential voltage ((V₂+)−(V₂−)) between the two junctions of the anisotropic magneto-resistive structures 211 and 213 and the anisotropic magneto-resistive structures 212 and 214. The resistance of the four anisotropic magneto-resistive structures 211, 212, 213, and 214 varies according to a second trigonometric function (cos(2θ)). Thus the output voltage Vₒᵤₜ_{_{—}}AMR2 of the second of the two anisotropic magneto-resistive sensing elements 210 is the function: Vₒᵤₜ_{_{—}}AMR2=V_{dd}/2 dR/R cos(2θ)

As is known, the characteristic of the anisotropic magneto-resistive effect of the two anisotropic magneto-resistive sensing elements 205 and 210, the resistance of the anisotropic magneto-resistive structures 206, 207, 208, 209, 211, 212, 213 and 214 change is a function of cos²(θ), where θ is the angle between the magnetization 225 and current flowing direction. It is further known that one anisotropic magneto-resistive Wheatstone bridge only detects 90° angle and that two anisotropic magneto-resistive sensors (or two anisotropic magneto-resistive Wheatstone bridges) with 45° orientation difference only allow a measurement of 180° angle. As shown above the output voltage signal 205 is Vₒᵤₜ_{_{—}}AMR1=V_{dd}/2 dR/R sin(2θ), while output voltage signal Vₒᵤₜ_{_{—}}AMR2 of the second of the two anisotropic magneto-resistive sensing elements that is orientated 45° differentially the from first of the two anisotropic magneto-resistive sensing elements 205 is Vₒᵤₜ_{_{—}}AMR2=V_{dd}/2 dR/R cos(2θ). The magneto-resistive ratio of anisotropic magneto-resistive film structures 206, 207, 208, 209, 211, 212, 213 and 214 is the change in the resistance due to the magnetic field vector versus the resistance of the anisotropic magneto-resistive film structures 206, 207, 208, 209, 211, 212, 213 and 214 with no magnetic field (dR/R). In another words, the measured angle is either the real magnetic field angle θ or its opposite direction θ+180°. In order to measure a full 360-degree angle, a magneto-resistive sensor element 215 is formed on the substrate of the integrated magnetic field angle detection sensor 200 of this invention with the two anisotropic magneto-resistive sensing elements 205 and 210. The magneto-resistive sensor element 215 has an magneto-resistive structure 216 that is either a giant magneto-resistive structure or a magnetic tunnel junction structure with a magnetic reference layer fixed or pinned to have a resistance that is proportional to sin(θ) of a magnetic field vector to the reference axis 220. A current is applied through the magneto-resistive sensor element 215 and the voltage drop across the magneto-resistive sensor element 215 is determined. The voltage output Vₒᵤₜ_{_{—}}GMR1 of the magneto-resistive sensor element 215 is determined by the function: Vₒᵤₜ_{_{—}}GMR1=A sin(θ) or Vₒᵤₜ_{_{—}}GMR1=A cos(θ) depending upon the fixed magnetization directions in the reference layer, where A is the amplitude depending upon bias current and magneto-resistive ratio of giant magneto-resistive films.

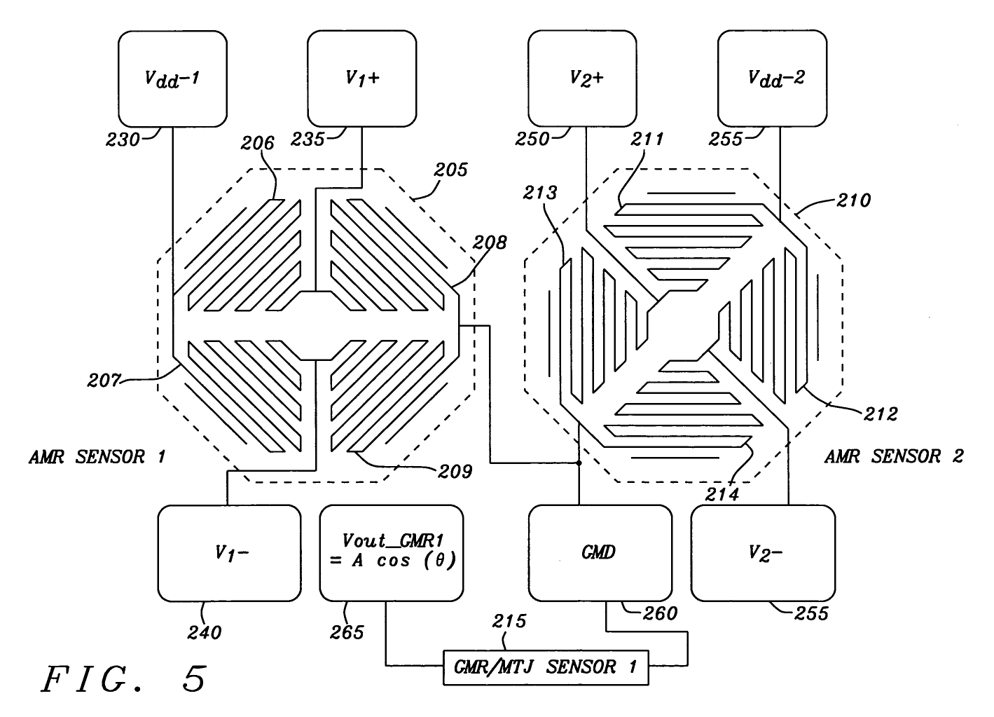

FIG. 5 provides a representational plan view of the integrated magnetic field angle detection sensor 200 of this invention. The two anisotropic magneto-resistive sensing elements 205 and 210 are shown with their respective anisotropic magneto-resistive film structures 206, 207, 208, 209, 211, 212, 213 and 214. These structures of the anisotropic magneto-resistive film structures 206, 207, 208, 209, 211, 212, 213 and 214 have a dielectric layer formed on the substrate. A seed layer is then deposited upon the dielectric layer and a ferromagnetic film dielectric layer deposited on the dielectric layer. The seed layer is NiFeCr, NiCr, Ta, or an equivalent alloy. The ferromagnetic layer is a binary alloy or a ternary alloy of Ni, Fe, Co, or equivalent ferromagnetic materials.

The each of the two anisotropic magneto-resistive sensing elements 205 and 210 have their respective four anisotropic magneto-resistive material structures 206, 207, 208, 209, 211, 212, 213 and 214 formed on the substrate and connected to form a Wheatstone bridge. The second Wheatstone bridge of the two anisotropic magneto-resistive sensing elements 210 is oriented parallel with the reference axis, as described above. The first Wheatstone bridge of the two anisotropic magneto-resistive sensing elements 205 is rotated by an orientation angle such that the second trigonometric function is the first trigonometric function shifted by the orientation angle. As described above, the first Wheatstone bridge is rotated by an angle of 45° such that the first trigonometric function is the sin(θ) and the second trigonometric function is the cosin(θ).

The power supply voltage source V_{dd}-1 is applied to the terminal 230 that is connected to the junction between the anisotropic magneto-resistive film structures 206 and 207. A ground reference voltage is applied to the terminal 260 that is connected to the junction between the anisotropic magneto-resistive film structures 208 and 209. The output voltage of the first of the two anisotropic magneto-resistive sensing elements 205 is developed between the terminal V₁+ 235 and terminal V₁− 240. As described above, this output voltage of the first of the two anisotropic magneto-resistive sensing elements 205 is the function: Vₒᵤₜ_{_{—}}AMR1=V_{dd}/2 dR/R sin(2θ).

The power supply voltage source V_{dd}-2 is applied to the terminal 245 that is connected to the junction between the anisotropic magneto-resistive film structures 211 and 212. The ground reference voltage, as applied to the terminal 260, is connected to the junction between the anisotropic magneto-resistive film structures 213 and 214. The output voltage of the second of the two anisotropic magneto-resistive sensing elements 210 is developed between the terminal V₂+ 250 and terminal V₂− 255. As described above, this output voltage of the second of the two anisotropic magneto-resistive sensing elements 210 is the function: Vₒᵤₜ_{_{—}}AMR2=V_{dd}/2 dR/R cos(2θ).

Integrated on the substrate with the two anisotropic magneto-resistive sensing elements 205 and 210 is the magneto-resistive sensor element 215 that has a giant magneto-resistive structure or a magnetic tunnel junction structure that is oriented to have a resistance that is proportional to sin(θ) of a magnetic field vector to the reference axis, as described above. A current is applied through the terminal 265 to the magneto-resistive sensor element 215 and the voltage output Vₒᵤₜ_{_{—}}GMR1 265 across the magneto-resistive sensor element 215 is determined by the function: Vₒᵤₜ_{_{—}}GMR1=A sin(θ), where A is the amplitude depending upon bias current and magneto-resistive ratio of the magneto-resistive films.

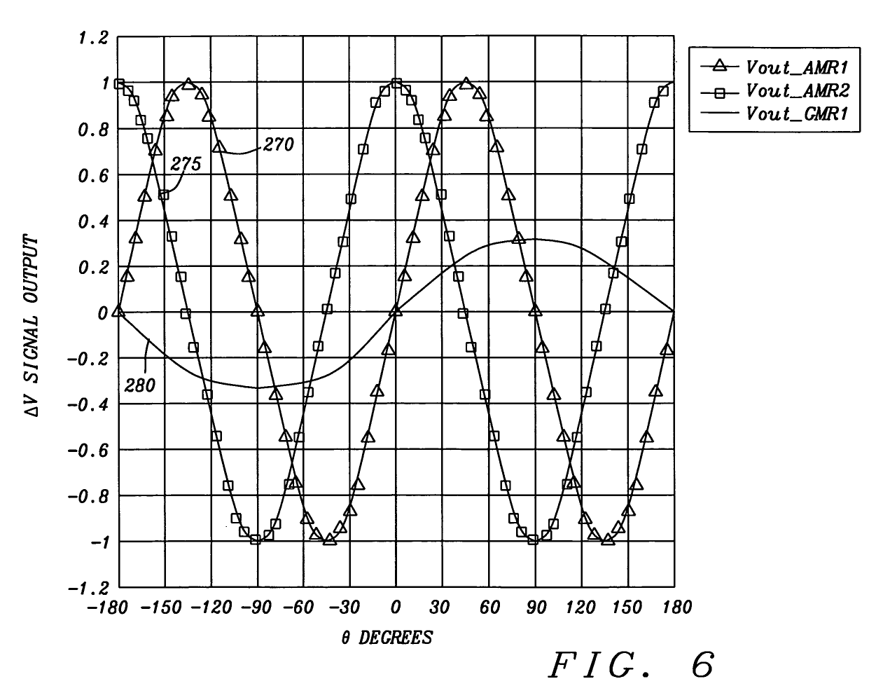

FIG. 6 illustrates plots of, the output voltage Vₒᵤₜ_{_{—}}AMR1 270 of the first of the two anisotropic magneto-resistive sensing elements 205, the output voltage Vₒᵤₜ_{_{—}}AMR2 275 of the second of the two anisotropic magneto-resistive sensing elements 210, and the output voltage Vₒᵤₜ_{_{—}}GMR1 280 of the magneto-resistive sensor element 215 as a function of the angle θ between the magnetization 225 and current flowing direction through the two anisotropic magneto-resistive sensing elements 205 and 210 and magneto-resistive sensor element 215.

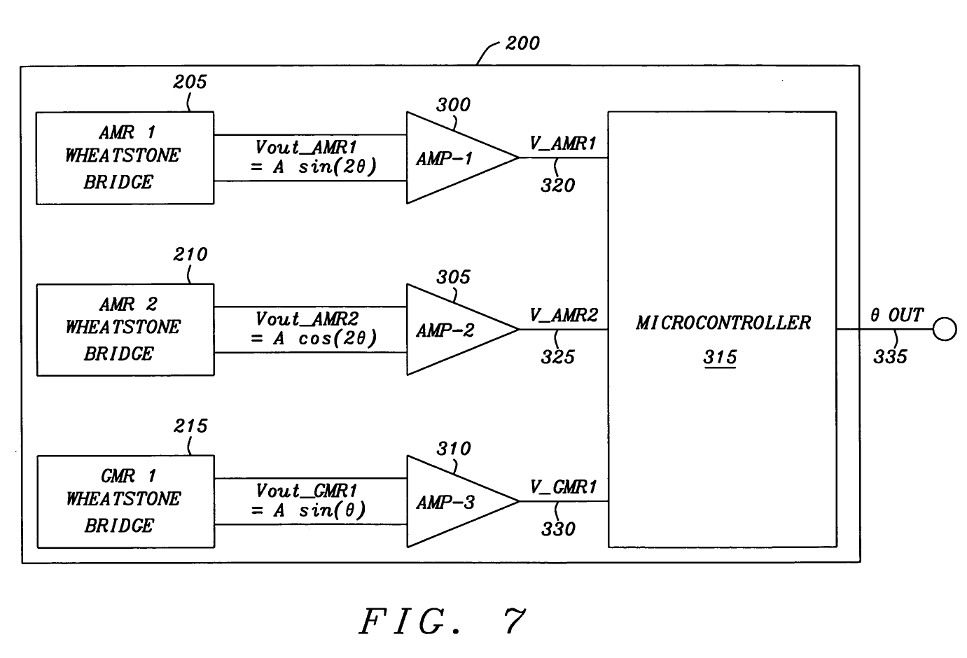

Referring to FIG. 7, the integrated magnetic field angle detection sensor 200 of this invention includes the two anisotropic magneto-resistive sensing elements 205 and 210 and the magneto-resistive sensor element 215 as described above. The three amplifiers 300, 305, and 310 and the microcontroller 315 for a magnetic field angle calculator. The magnetic field angle calculator is fabricated on the substrate employing standard semiconductor processing techniques prior to the deposition of the two anisotropic magneto-resistive sensing elements 205 and 210 and the magneto-resistive sensor element 215 upon the substrate.

The output voltage Vₒᵤₜ_{_{—}}AMR1 of the first of the two anisotropic magneto-resistive sensing elements 205 is the input to a first amplifier 300. The first amplifier 300 amplifies and conditions the output voltage Vₒᵤₜ_{_{—}}AMR1 of the first of the two anisotropic magneto-resistive sensing elements 205. The second amplifier 305 amplifies and conditions the output voltage Vₒᵤₜ_{_{—}}AMR2 of the second of the two anisotropic magneto-resistive sensing elements 210. The third amplifier 310 amplifies and conditions the output voltage Vₒᵤₜ_{_{—}}GMR1 280 of the magneto-resistive sensor element 215. The outputs 320, 325, and 330 of the three amplifiers 300, 305, and 310 are the inputs to the microcontroller 315.

The output voltage 320 of the first amplifier 300 is proportional to output voltage Vₒᵤₜ_{_{—}}AMR1 of the first of the two anisotropic magneto-resistive sensing elements 205 that is the function: Vₒᵤₜ_{_{—}}AMR1=V_{dd}/2 dR/R sin(2θ). Similarly, the output voltage 325 of the first amplifier 305 is proportional to output voltage Vₒᵤₜ_{_{—}}AMR2 of the second of the two anisotropic magneto-resistive sensing elements 210 that is the function: Vₒᵤₜ_{_{—}}AMR2=V_{dd}/2 dR/R cos(2θ).

It can be shown that the magnitude of the output voltage Vₒᵤₜ_{_{—}}AMR1 of the first of the two anisotropic magneto-resistive sensing elements 205 and output voltage Vₒᵤₜ_{_{—}}AMR2 of the first of the two anisotropic magneto-resistive sensing elements 210 are different but they are directly dependent upon the sine and cosine of the angle (θ) between the reference axis and the applied magnetic field vector. The gains of the first amplifier 300 and the second amplifier 305 are adjusted such that the output voltage 320 and 325 have equal magnitude and only vary as a function of the sine for the output voltage 320 and the cosine for the output voltage 325. The angle θ is determined as arctangent of the ratios of the output voltage 320 and the output voltage 325 (θ=arc tan(V_AMR1/V_AMR2). The arctangent function is easily determined using a memory map in the microcontroller circuit 315. The resulting angle θ is an output 335 of the microcontroller circuit 315 or alternately is processed further within the microcontroller circuit 315.

The output voltages of the two anisotropic magneto-resistive sensing elements 205 and 210 can be used to determine an angle (θ) very precisely if its quadrant is known. This is due to the fact that output voltages of the two anisotropic magneto-resistive sensing elements 205 and 210 have a period of 180° instead of 360°. Because of this, the first quadrant and third quadrant or the second quadrant and the fourth quadrant are indistinguishable. The output voltage Vₒᵤₜ_{_{—}}GMR1 of the magneto-resistive sensor element 215 provides output as A sin(θ), where A is the amplitude depending upon bias voltage and magneto-resistive ratio of magneto-resistive sensor element 215. Due to the limited pinning field on reference layer, the magneto-resistive sensor element 215 may deviate slightly from ideal sinusoidal functions, however this sufficient determining the quadrant of the angle.

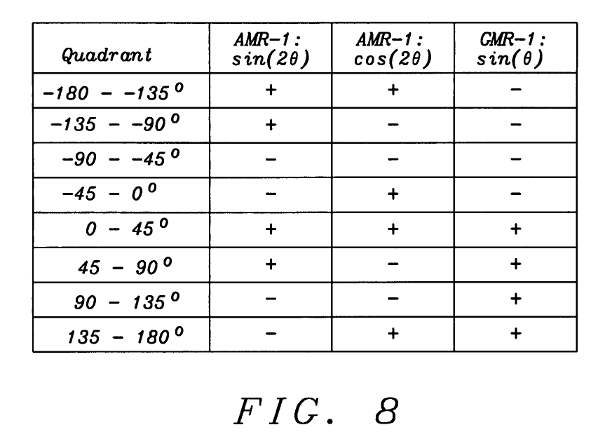

As shown in the table of FIG. 8, the two anisotropic magneto-resistive sensing elements 205 and 210 give measured angle θ, or θ ±180°, where θ is the magnetic field angle. For example, if the magnetic field angle is 30°, the two anisotropic magneto-resistive sensing elements 205 and 210 give measured value 30° or −150°. In another words, they could not distinguish 30° or −150°. Using the help of the magneto-resistive sensor element 215, the quadrant is easily determined. If the angle is between 0° to 180°, the output voltage of the magneto-resistive sensor element 215 is positive. Alternately, if the angle is between −180° to 0°, the output voltage of the magneto-resistive sensor element 215 is negative.

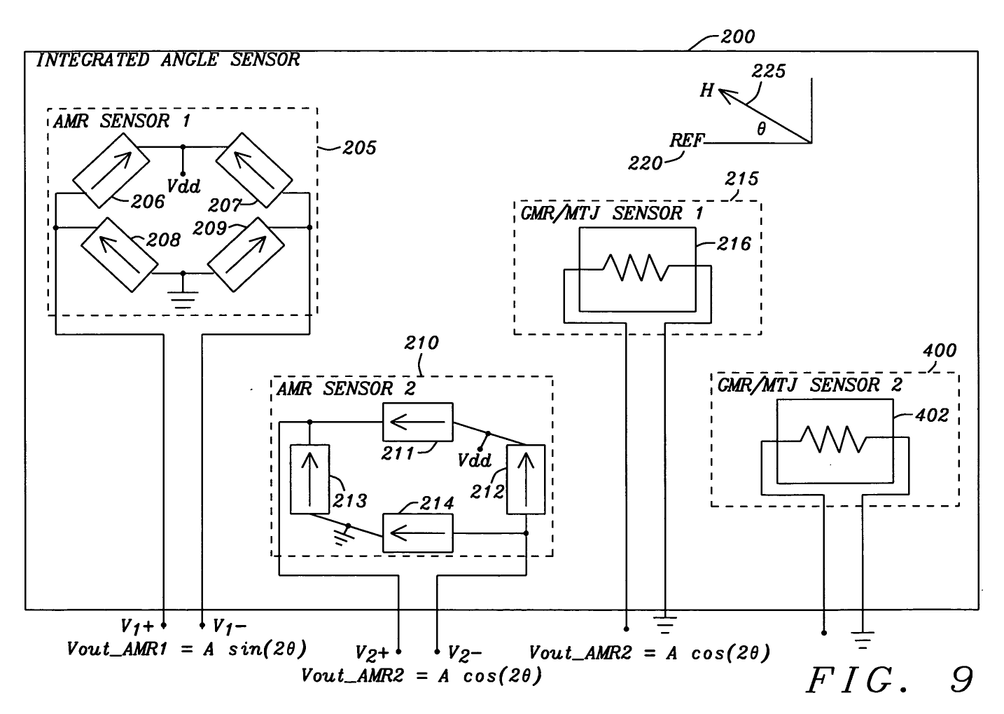

Refer now to FIG. 9 for a discussion of a second embodiment of the integrated magnetic field angle detection sensor 400 of this invention. The basic structure of the integrated magnetic field angle detection sensor 400 is identical to that of the first embodiment of the integrated magnetic field angle detection sensor 200 of FIG. 4. An additional magneto-resistive sensor element 400 is added to the integrated magnetic field angle detection sensor 200 of FIG. 4. In the integrated magnetic field angle detection sensor 200 of FIG. 4, the only magnetic angle vector 225 values which the magneto-resistive sensor element 215 can not distinguish are 0° or 180°. In this special case, a magneto-resistive sensor element 400 permits distinguishing the magnetic angle vector 225 at 0° or magneto-resistive sensor element 400 is positive. The angle is 180° when the output voltage Vₒᵤₜ_{_{—}}GMR2 of the second magneto-resistive sensor element 400 is negative.

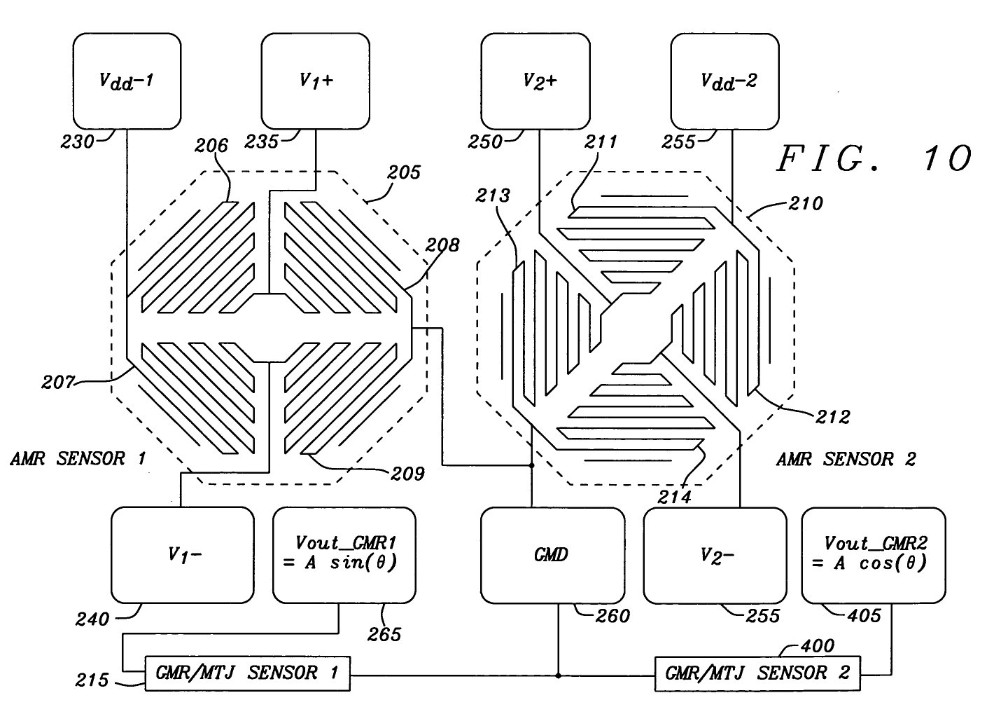

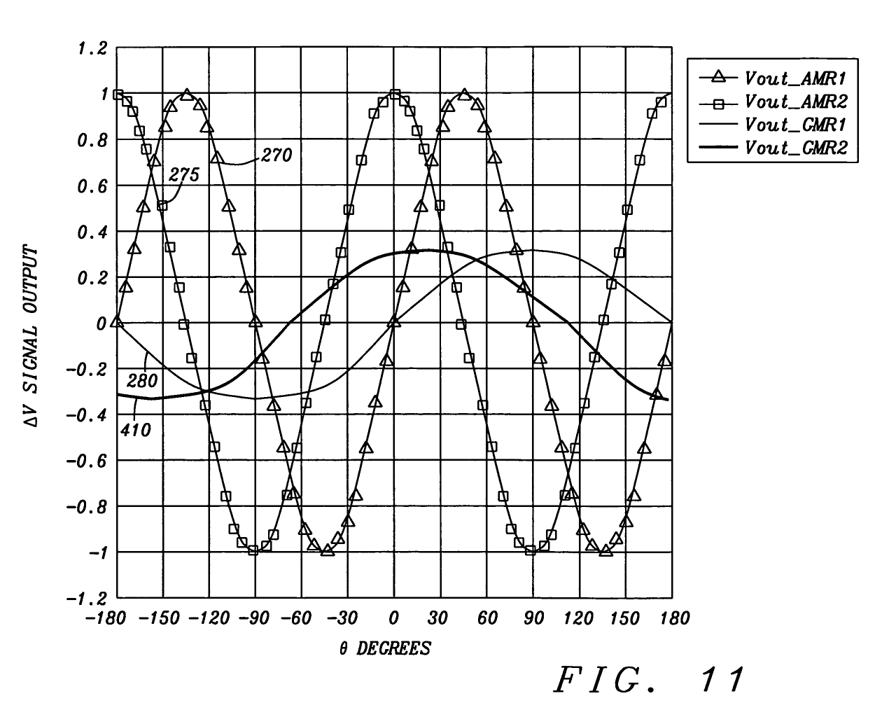

As shown in FIG. 10, the second magneto-resistive sensor element 400 is integrated on the substrate with the two anisotropic magneto-resistive sensing elements 205 and 210 and the magneto-resistive sensor element 215. The second magneto-resistive sensor element 400 has a giant magneto-resistive structure or a magnetic tunnel junction structure that has pinned reference magnetization perpendicular to the pinned reference magnetization of the first element 215 to have a resistance that is proportional to cos(θ) of a magnetic field vector to the reference axis, as described above. A current is applied through the terminal 405 to the second magneto-resistive sensor element 400 and the voltage output Vₒᵤₜ_{_{—}}GMR2 across the second magneto-resistive sensor element 400 is determined by the function: Vₒᵤₜ_{_{—}}GMR2=A cos(θ), where A is the amplitude depending upon bias current and magneto-resistive ratio of the magneto-resistive films. In FIG. 11, the plots 270, 275, and 280 of the output voltages of the two anisotropic magneto-resistive sensing elements 205 and 210 and the magneto-resistive sensor element 215 are as described in FIG. 6. The plot of the output voltage Vₒᵤₜ_{_{—}}GMR2 410 of the second magneto-resistive sensor element 400 demonstrates that the combination of the signs of the output voltage Vₒᵤₜ_{_{—}}GMR1 280 of the second magneto-resistive sensor element 215 and the output voltage Vₒᵤₜ_{_{—}}GMR2 410 of the second magneto-resistive sensor element 400 provides the necessary information for differentiating the value of the angle (θ) of the magnetic field vector at 0° and 180°.

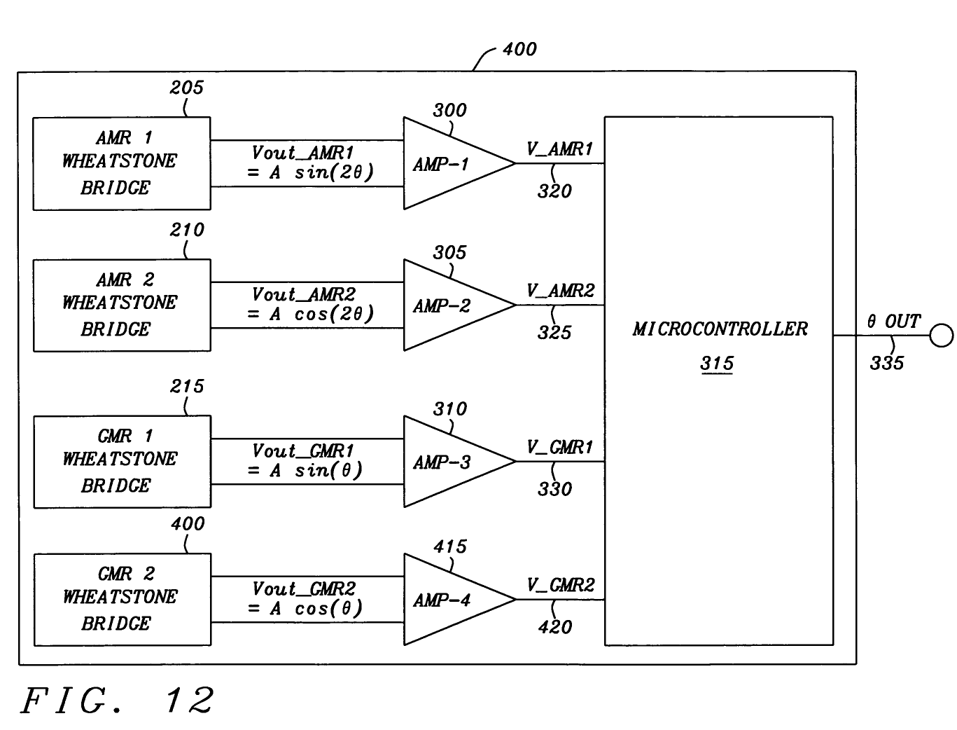

Referring now to FIG. 12, the second embodiment of the integrated magnetic field angle detection sensor 400 of this invention includes the two anisotropic magneto-resistive sensing elements 205 and 210 and the magneto-resistive sensor elements 215 and 400 with the three amplifiers 300, 305, and 310 and the microcontroller 315 are fabricated on the substrate as described above. The third amplifier 3100 amplifies and conditions the output voltage Vₒᵤₜ_{_{—}}GMR2 of the magneto-resistive sensor element 400. The outputs 320, 325, 330, and 420 of the four amplifiers 300, 305, 310, and 420 are the inputs to the microcontroller 315.

As described above, the output voltage 320 of the first amplifier 300 is proportional to output voltage Vₒᵤₜ_{_{—}}AMR1 of the first of the two anisotropic magneto-resistive sensing elements 205 that is the function: Vₒᵤₜ_{_{—}}AMR1=V_{dd}/2 dR/R sin(2θ). Similarly, the output voltage 325 of the first amplifier 305 is proportional to output voltage Vₒᵤₜ_{_{—}}AMR2 of the second of the two anisotropic magrleto-resistive sensing elements 210 that is the function: Vₒᵤₜ_{_{—}}AMR2=V_{dd}/2 dR/R cos(2θ).

It can be shown that the magnitude of the output voltage Vₒᵤₜ_{_{—}}AMR1 of the first of the two anisotropic magneto-resistive sensing elements 205 and output voltage Vₒᵤₜ_{_{—}}AMR2 of the first of the two anisotropic magneto-resistive sensing elements 210 are different but they are directly dependent upon the sine and cosine of the angle (θ) between the reference axis and the applied magnetic field vector. The gains of the first amplifier 300 and the second amplifier 305 are adjusted such that the output voltage 320 and 325 have equal magnitude and only vary as a function of the sine for the output voltage 320 and the cosine for the output voltage 325. The angle θ is determined as arctangent of the ratios of the output voltage 320 and the output voltage 325 (θ=arctan(V_AMR1/V_AMR2). The arctangent function is easily determined using a memory map in the microcontroller circuit 315. The resulting angle θ is an output 335 of the microcontroller circuit 315 or alternately is processed further within the microcontroller circuit 315.

The output voltages of the two anisotropic magneto-resistive sensing elements 205 and 210 can be used to determine an angle (θ) very precisely if its quadrant is known. This is due to the fact that output voltages of the two anisotropic magneto-resistive sensing elements 205 and 210 have a period of 180° instead of 360°. Because of this, the first quadrant and third quadrant or the second quadrant and the fourth quadrant are indistinguishable. The output voltage Vₒᵤₜ_{_{—}}GMR1 of the magneto-resistive sensor element 215 and the output voltage Vₒᵤₜ_{_{—}}GMR2 of the magneto-resistive sensor element 400 provide output voltages that vary as A sin(θ), where A is the amplitude depending upon bias voltage and magneto-resistive ratio of magneto-resistive sensor element 215. Due to the limited pinning field on reference layer, the magneto-resistive sensor element 215 and the magneto-resistive sensor element 400 may deviate slightly from ideal sinusoidal functions, however this sufficient determining the quadrant of the angle.

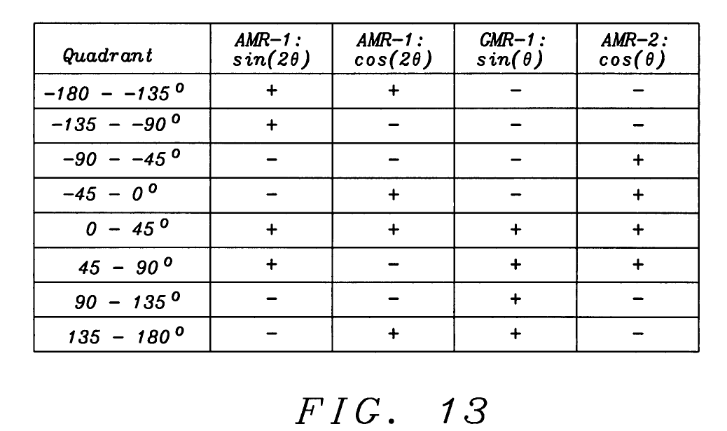

As shown in the table of FIG. 13, the two anisotropic magneto-resistive sensing elements 205 and 210 give measured angle θ, or θ ±180°, where θ is the magnetic field angle. For example, if the magnetic field angle is 30°, the two anisotropic magneto-resistive sensing elements 205 and 210 give measured value 30° or −150°. The two anisotropic magneto-resistive sensing elements 205 and 210 can not distinguish 30° or −150°. Using the help of the magneto-resistive sensor element 215, the quadrant is easily determined. If the angle is between 0° to 180°, the output voltage of the magneto-resistive sensor element 215 is positive. Alternately, if the angle is between −180° to, 0°, the output voltage of the magneto-resistive sensor element 215 is negative. Further, as noted above, the only magnetic angle vector values which the magneto-resistive sensor element 215 can not distinguish are 0° or 180°. In this special case, a magneto-resistive sensor element 400 permits distinguishing the magnetic angle vector 225 at 0° or 180°. The angle is 0° when the output voltage Vₒᵤₜ_{_{—}}GMR2 of the second magneto-resistive sensor element 400 is positive. The angle is 180° when the output voltage Vₒᵤₜ_{_{—}}GMR2 of the second magneto-resistive sensor element 400 is negative.

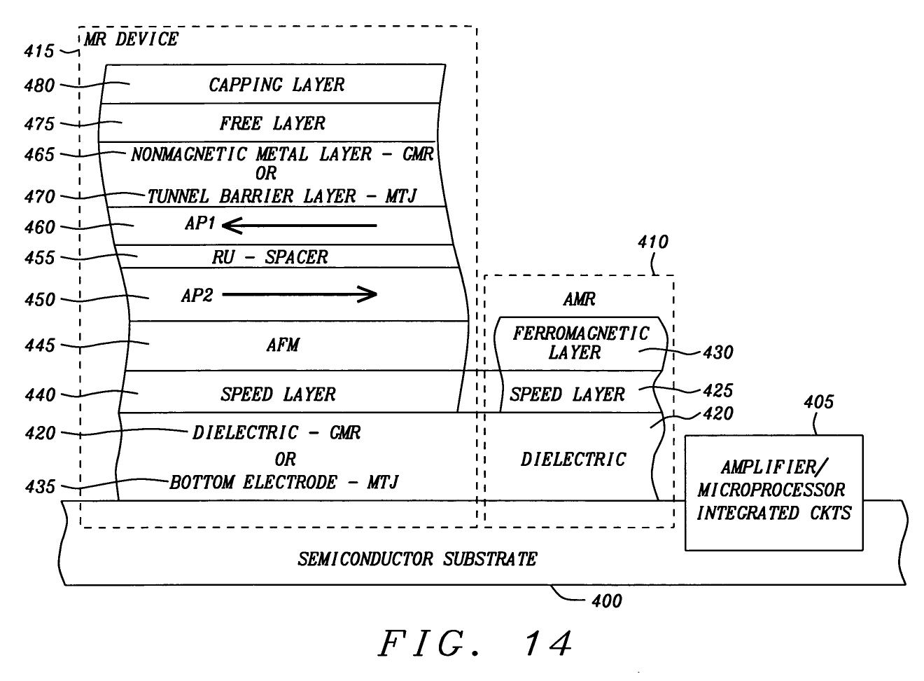

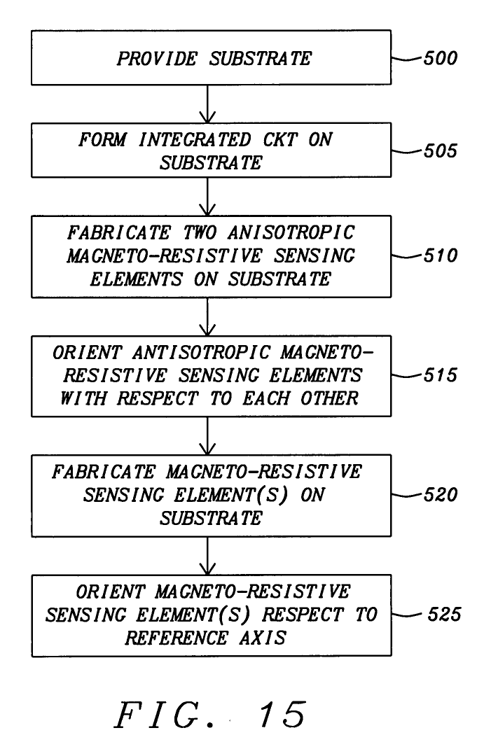

Refer now to FIGS. 14 and 15 for a method for fabricating an integrated angular magnetic sensor that determines a magnetic field angle within two axes of a plane. The method begins by providing (Box 500) the substrate 400. A magnetic field angle calculator circuit formed (Box 505) as an integrated circuit 405 on the substrate 400. The magnetic field angle calculator circuit of the integrated circuit 405 includes the amplifiers and microprocessor as described above for determining the magnetic field angle. The amplifiers and microprocessor are formed by the creation and interconnection of semiconductor devices on the substrate 400. The two anisotropic magneto-resistive sensing elements 410 are fabricated (Box 510) on the substrate and are oriented (Box 515) with respect to each other such that an output voltage of a first of the anisotropic magneto-resistive sensing elements 410 is a function of a first trigonometric function (sine function) of the magnetic field angle to a reference axis and an output voltage of a second of the anisotropic magneto-resistive sensing elements is a function of a second trigonometric function (cosine function) of the magnetic field angle to the reference axis. Fabricating (Box 510) each of the two anisotropic magneto-resistive sensing elements includes forming four anisotropic magneto-resistive material structures 410 on the substrate 400 for each of the two anisotropic magneto-resistive sensing elements. The four anisotropic magneto-resistive material structures 410 are connected to form a Wheatstone bridge. One of the Wheatstone bridges of the two anisotropic magneto-resistive sensing elements 410 is oriented (Box 515) with respect to the second Wheatstone bridge by an orientation angle such that the second trigonometric function is the first trigonometric function shifted by the orientation angle.

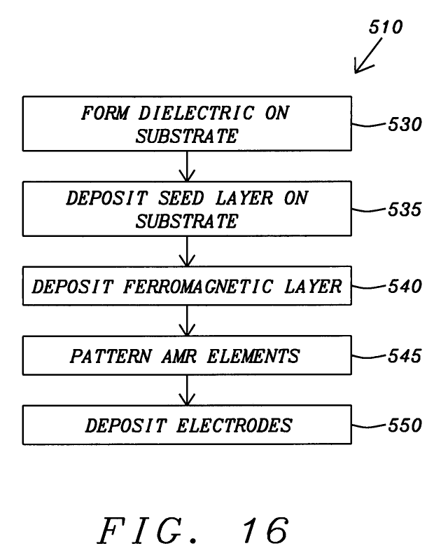

Refer now to FIG. 16 for a description of the fabricating (Box 510) of the four anisotropic magneto-resistive material structures 410 of the Wheatstone bridges of the two anisotropic magneto-resistive sensing elements. The four anisotropic magneto-resistive material structures 410 are fabricated (Box 510) by first forming (Box 530) a dielectric layer 420 on the substrate 400. A seed layer 425 is then deposited (Box 535) upon the dielectric layer 420 and a ferromagnetic film is deposited (Box 540) dielectric layer on the substrate. The seed layer is formed of NiFeCr, NiCr, Ta, or an equivalent alloy. The ferromagnetic layer is a binary alloy or a ternary alloy of Ni, Fe, Co, or equivalent ferromagnetic materials.

A photo-mask of the four anisotropic magneto-resistive material structures 410 that is patterned (Box 545) into large rectangle-shaped anisotropic magneto-resistive material stripes. The four anisotropic magneto-resistive material structures 410 are then etched to define the four anisotropic magneto-resistive material structures 410. The electrodes for the four anisotropic magneto-resistive material structures 410 are deposited (Box 550) to connect the two anisotropic magneto-resistive sensing elements 410 two anisotropic magneto-resistive sensing elements 410 to form the Wheatstone bridges.

One or two magneto-resistive sensing elements 415 is formed (Box 520) on the substrate and is oriented (Box 525) with respect to the reference axis such that an output voltage of the magneto-resistive sensing elements 415 provide a quadrant indicator for the magnetic field angle with respect to the reference axis. The magneto-resistive sensing elements 415 are either giant-magneto-resistive structures or are magnetic tunnel junction structures.

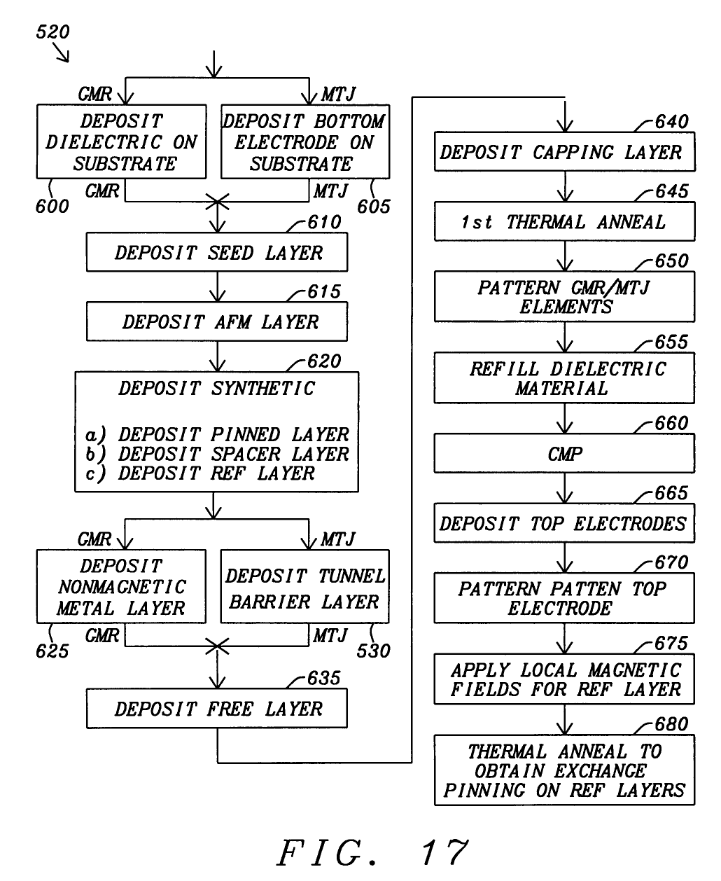

Refer now to FIG. 17 for a description of the forming (Box 520) of the magneto-resistive sensing elements 415. If the magneto-resistive sensing elements 415 are giant-magneto-resistive structures, a dielectric material 420 is deposited (Box 600) on the substrate. As shown the dielectric material 420 of the giant-magneto-resistive structure is the same dielectric material 420 of the anisotropic magneto-resistive material structure 410. If the magneto-resistive sensing elements 415 are magnetic tunnel junction structures, a bottom electrode material 435 is deposited (Box 605) on the substrate 400.

A seed layer 440 is deposited (Box 610) upon said dielectric layer 420 or the bottom electrode material 435. This seed layer may be identical to the seed layer 425 of the anisotropic magneto-resistive material structure 410. An anti-ferromagnetic layer 445 is deposited (Box 615) upon the seed layer 425 with a synthetic pinned multilayer deposited (Box 620) on the anti-ferromagnetic layer 445. The anti-ferromagnetic layer formed of binary alloys or tertiary alloys of Pt, Mn, Pd, or equivalent anti-ferromagnetic materials. The synthetic pinned multilayer is formed by depositing a synthetic pinned layer 450 upon the anti-ferromagnetic layer 445. A conductive nonmagnetic spacer layer 455 is deposited upon the synthetic pinned layer 450. A second anti-parallel layer 460 is deposited upon the nonmagnetic space layer 455. The first and second anti-parallel structures are formed of a ferromagnetic layer that is a binary alloy or ternary alloy of Ni, Fe, Co, B or equivalent ferromagnetic material. The non-magnetic space layer 455 is Ru or equivalent nonmagnetic material.

If the magneto-resistive sensing element 415 is the giant-magneto-resistive structure, a non-magnetic metal layer 465 is deposited (Box 625) on the second anti-parallel layer 460. Alternately, if the magneto-resistive sensing element 415 is a magnetic tunnel junction structure a tunnel barrier layer 470 is deposited (Box 630) on the second anti-parallel layer 460. A free layer 475 is deposited (Box 635) upon either the non-magnetic metal layer 465 or the magnetic tunnel junction 470. The free layer 475 is a ferromagnetic material that is a binary alloy or ternary allow of Ni, Fe, Co, B, or equivalent ferromagnetic material. A capping layer is deposited (Box 640) on the free layer 475.

The magneto-resistive sensing elements 415 are exposed (Box 645) to a first thermal anneal. A photo-mask of the magneto-resistive sensing element 415 to pattern (Box 650) the magneto-resistive sensing elements 415 into large rectangle-shaped giant-magneto-resistive stripes with a large aspect ratio and different orientations of long axes or into magnetic tunnel junction structures. The patterned elements are then etched to complete the patterning (Box 650) of the magneto-resistive sensing element 415. The patterning (Box 650) of the magneto-resistive sensing element 415 may be identical to the patterning (Box 545) of the anisotropic magneto-resistive material structures 410 as described in FIG. 16 and may be performed simultaneously.

Dielectric material is refilled (Box 655) to cover the magneto-resistive sensing element 415 and the surface is chemical-mechanical polished (Box 660). The top electrodes are deposited (Box 665) and patterned (Box 670) to form the connections to connect the magneto-resistive sensing elements 415 to the magnetic field angle calculator circuit 405. Local magnetic fields are applied (Box 675) magneto-resistive sensing elements 415 for setting the field orientation of the reference layers of the first and second anti-parallel layer 450 and 460. The magneto-resistive sensing element 415 is thermally annealed (Box 80) to obtain exchange pinning on reference layers with various predetermined directions for each of the magneto-resistive sensing elements 415. The local magnetic fields are shape anisotropy fields, stress-induced magnetostrictive anisotropy fields, local hard bias fields, or local flux concentrating fields by adjacent soft magnetic layers.

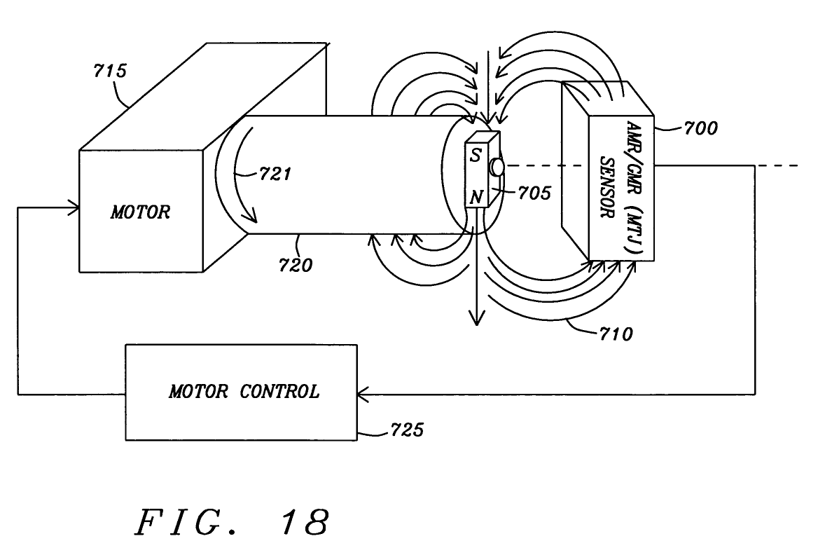

FIG. 18 shows a full 360° rotational position sensing solution that uses the integrated angular magnetic sensor 700 of this invention that determines a magnetic field angle within two axes of a plane. As described above, the integrated angular magnetic sensor 700 of this invention incorporates two of the AMR Wheatstone bridge sensors combined one or two magneto-resistive sensing elements. A motor 715 rotates a shaft 720 in a designated direction 721. A magnet 705 is placed at the end of the shaft 720 and is rotated with the shaft 720. The magnetic flux 710 from the magnet 705 exits the north pole (N) of the magnet 120 and returns to the south pole (S) of the magnet 705. The integrated angular magnetic sensor 700 is placed on the shaft axis, just above the magnet 705, the magnetic flux 710 passing through the integrated angular magnetic sensor 700 will retain the orientation of the magnet 705. From this rotation, the output of the anisotropic magneto-resistive sensing elements will create sine 270 and cosine 275 waveforms of FIGS. 6 and 11. The magnetic flux angle is determined as by the magnetic field angle calculator circuit of the integrated circuit of the integrated angular magnetic sensor 700. The magneto-resistive sensing elements provide the sine and/or cosine waveforms that determine the quadrant of the magnetic field angle of the magnetic flux 710.

While this invention has been particularly shown and described with reference to the preferred embodiments thereof, it will be understood by those skilled in the art that various changes in form and details may be made without departing from the spirit and scope of the invention.

The invention claimed is:

1. An angular magnetic sensor to determine a magnetic field angle within two axes of a plane, said angular magnetic sensor comprises:
two anisotropic magneto-resistive sensing elements fabricated on a substrate and oriented with respect to each other such that an output voltage of a first of said anisotropic magneto-resistive sensing elements is a function of a first trigonometric function of said magnetic field angle to a reference axis and an output voltage of a second of said anisotropic magneto-resistive sensing elements is a function of a second trigonometric function of said magnetic field angle to said reference axis; and
at least one magneto-resistive sensing element fabricated on said substrate and having a fixed reference magnetization oriented with respect to said reference axis such that an output voltage of said at least one magneto-resistive sensing element provides a quadrant indicator for said magnetic field angle with respect to said reference axis.

2. The angular magnetic sensor of claim 1 wherein each of said anisotropic magneto-resistive sensing elements comprise four anisotropic magneto-resistive material structures formed on said substrate and connected to form a Wheatstone bridge, one Wheatstone bridge rotated by an orientation angle such that the second trigonometric function is the first trigonometric function shifted by said orientation angle.

3. The angular magnetic sensor of claim 1 wherein the at least one magneto-resistive sensing element is a giant-magneto-resistive structure formed on said substrate.

4. The angular magnetic sensor of claim 1 wherein the at least one magneto-resistive sensing element is a magnetic tunnel junction structure formed on said substrate.

5. The angular magnetic sensor of claim 1 further comprising a magnetic field angle calculator connected to receive said output voltages of said two anisotropic magneto-resistive sensing elements and said output voltage of said at least one magneto-resistive sensing elements to determine the magnetic field angle.

6. The angular magnetic sensor of claim 5 wherein the first trigonometric function is a sine function and the second trigonometric function is a cosine function.

7. The angular magnetic sensor of claim 5 wherein the magnetic field angle is a function of a ratio of said first of said anisotropic magneto-resistive sensing elements to said output voltage of said a second of said anisotropic magneto-resistive sensing elements.

8. The angular magnetic sensor of claim 7 wherein said function is one half an arctangent of said ratio.

9. The angular magnetic sensor of claim 8 wherein said magnetic field angle calculator determines magnetic field angle as a magnitude of said arctangent of said ratio and a sign from said at least one magneto-resistive sensing element.

10. A method for fabricating an angular magnetic sensor comprising the steps of:
providing a substrate;
forming two anisotropic magneto-resistive sensing elements fabricated on said substrate and oriented with respect to each other such that an output voltage of a first of said anisotropic magneto-resistive sensing elements is a function of a first trigonometric function of said magnetic field angle to a reference axis and an output voltage of a second of said anisotropic magneto-resistive sensing elements is a function of a second trigonometric function of said magnetic field angle to said reference axis; and
forming at least one magneto-resistive sensing element on said substrate and having a fixed reference magnetization oriented with respect to said reference axis such that an output voltage of said at least one magneto-resistive sensing element provides a quadrant indicator for said magnetic field angle with respect to said reference axis.

11. The method for fabricating an angular magnetic sensor of claim 10 wherein the step of forming said anisotropic magneto-resistive sensing elements comprises the steps of:
forming four anisotropic magneto-resistive material structures on said substrate for each of said anisotropic magneto-resistive sensing elements;
connecting said four anisotropic magneto-resistive material structures to form a Wheatstone bridge; and
rotating one Wheatstone bridge by an orientation angle such that the second trigonometric function is the first trigonometric function shifted by said orientation angle.

12. The method for fabricating an angular magnetic sensor of claim 11 wherein forming four anisotropic magneto-resistive material structures on said substrate comprises the steps of:
forming a dielectric layer on said substrate;
depositing a seed layer upon said dielectric layer; and
depositing a ferromagnetic film dielectric layer on said substrate.

13. The method for fabricating an angular magnetic sensor of claim 10 wherein the at least one magneto-resistive sensing element is a giant-magneto-resistive structure formed on said substrate.

14. The method for fabricating an angular magnetic sensor of claim 13 wherein forming the at least one magneto-resistive sensing element comprises the steps of:
forming a dielectric layer upon said substrate.
depositing a seed layer upon said dielectric layer;
depositing an anti-ferromagnetic layer upon said seed layer;
depositing a synthetic pinned layer upon said anti-ferromagnetic layer;
depositing a conductive layer upon said synthetic pinned layer; and
depositing a free layer upon said conductive layer.

15. The method for fabricating an angular magnetic sensor of claim 14 wherein forming said synthetic pinned layer comprises the steps of
depositing a first anti-parallel structure upon said anti-ferromagnetic layer;
depositing a nonmagnetic space layer upon said first anti-parallel structure; and
depositing a second anti-parallel structure upon said nonmagnetic space layer.

16. The method for fabricating an angular magnetic sensor of claim 15 wherein forming the at least one magneto-resistive sensing element further comprises the steps of:
creating a photo-mask of said at least one magneto-resistive sensing element that is patterned into large rectangle-shaped giant-magneto-resistive stripes with a large aspect ratio and different orientations of long axes, and
forming said at least one magneto-resistive sensing element on said substrate by the step of etching said substrate to define said at least one magneto-resistive sensing element.

17. The method for fabricating an angular magnetic sensor of claim 16 wherein forming the at least one magneto-resistive sensing element further comprises the steps of:
applying local magnetic fields to said at least one magneto-resistive sensing element; and
thermally annealing said at least one magneto-resistive sensing element to obtain exchange pinning on reference layers with various predetermined directions for each of said giant-magneto-resistive stripes.

18. The method for fabricating an angular magnetic sensor of claim 17 wherein said local magnetic fields are shape anisotropy fields, stress-induced magnetostrictive anisotropy fields, local hard bias fields, or local flux concentrating fields by adjacent soft magnetic layers.

19. The method for fabricating an angular magnetic sensor of claim 10 wherein the at least one magneto-resistive sensing element is a magnetic tunnel junction structure formed on said substrate.

20. The method for fabricating an angular magnetic sensor of claim 19 wherein forming the at least one magneto-resistive sensing element comprises the steps of:
forming a dielectric layer upon said substrate.
depositing a seed layer upon said dielectric layer;
depositing an anti-ferromagnetic layer upon said seed layer;
depositing a synthetic pinned layer upon said anti-ferromagnetic layer;
depositing a tunneling layer upon said synthetic pinned layer; and
depositing a free layer upon said conductive layer.

21. The method for fabricating an angular magnetic sensor of claim 20 wherein forming said synthetic pinned layer comprises the steps of:
depositing a first anti-parallel structure upon said anti-ferromagnetic layer;
depositing a nonmagnetic space layer upon said first anti-parallel structure; and
depositing a second anti-parallel structure upon said nonmagnetic space layer.

22. The method for fabricating an angular magnetic sensor of claim 21 wherein forming the at least one magneto-resistive sensing element further comprises the steps of:
creating a photo-mask of said at least one magneto-resistive sensing element that is patterned into large rectangle-shaped giant-magneto-resistive stripes with a large aspect ratio and different orientations of long axes, and
forming said at least one magneto-resistive sensing element on said substrate by the step of etching said substrate to define said at least one magneto-resistive sensing element.

23. The method for fabricating an angular magnetic sensor of claim 22 wherein forming the at least one magneto-resistive sensing element further comprises the steps of:
applying local magnetic fields to said at least one magneto-resistive sensing element; and
thermally annealing said at least one magneto-resistive sensing element to obtain exchange pinning on reference layers with various predetermined directions for each of said giant-magneto-resistive stripes.

24. The method for fabricating an angular magnetic sensor of claim 23 wherein said local magnetic fields are shape anisotropy fields, stress-induced magnetostrictive anisotropy fields, local hard bias fields, or local flux concentrating fields by adjacent soft magnetic layers.

25. The method for fabricating an angular magnetic sensor of claim 10 further comprising the steps of:
forming a magnetic field angle calculator circuit on said substrate by the steps of:
forming and connecting semiconductor devices on said substrate;
providing biasing voltages to said two anisotropic magneto-resistive sensing elements and said at least one magneto-resistive sensing element;
receiving a first output voltage and a second output voltage from said two anisotropic magneto-resistive sensing elements and at least a third output voltage from said at least one magneto-resistive sensing elements to determine a field angle of a magnetic field impinging upon said angular magnetic sensor.

26. An integrated angular magnetic sensor apparatus for determining a magnetic field angle within two axes of a plane, said integrated angular magnetic sensor apparatus comprising:
a substrate;
two anisotropic magneto-resistive sensing elements fabricated on said substrate and oriented with respect to each other such that an output voltage of a first of said anisotropic magneto-resistive sensing elements is a function of a first trigonometric function of said magnetic field angle to a reference axis and an output voltage of a second of said anisotropic magneto-resistive sensing elements is a function of a second trigonometric function of said magnetic field angle to said reference axis;
at least one magneto-resistive sensing element on said substrate and having a fixed reference magnetization oriented with respect to said reference axis such that an output voltage of said at least one magneto-resistive sensing element provides a quadrant indicator for said magnetic field angle with respect to said reference axis; and
a magnetic field angle calculator connected to receive said output voltages of said two anisotropic magneto-resistive sensing elements and said output voltage of said at least one magneto-resistive sensing elements to determine the magnetic field angle.

27. The integrated angular magnetic sensor apparatus of claim 26 wherein each of said two anisotropic magneto-resistive sensing elements comprise:
four anisotropic magneto-resistive material structures formed on said substrate and connected to form a Wheatstone bridge, wherein one Wheatstone bridge is rotated by an orientation angle such that the second trigonometric function is the first trigonometric function shifted by said orientation angle.

28. The integrated angular magnetic sensor apparatus of claim 27 wherein each of said four anisotropic magneto-resistive material structures formed on said substrate comprises:
a dielectric layer formed on said substrate;
a seed layer deposited upon said dielectric layer; and
a ferromagnetic film dielectric layer deposited on said dielectric layer.

29. The integrated angular magnetic sensor apparatus of claim 26 wherein the at least one magneto-resistive sensing element is a giant-magneto-resistive structure formed on said substrate.

30. The integrated angular magnetic sensor apparatus of claim 29 wherein the at least one magneto-resistive sensing element comprises:
a dielectric layer formed upon said substrate;
an anti-ferromagnetic layer deposited upon said dielectric layer;
a synthetic pinned layer deposited upon said anti-ferromagnetic layer;
a conductive layer deposited upon said synthetic pinned layer; and
a free layer deposited upon said conductive layer.

31. The integrated angular magnetic sensor apparatus of claim 30 wherein said synthetic pinned layer comprises:
a first anti-parallel structure deposited upon said anti-ferromagnetic layer;
a nonmagnetic space layer deposited upon said first anti-parallel structure; and
a second anti-parallel structure deposited upon said nonmagnetic space layer.

32. The integrated angular magnetic sensor apparatus of claim 30 wherein the at least one magneto-resistive sensing element is patterned by a photo-mask into large rectangle-shaped giant-magneto-resistive stripes with a large aspect ratio and different orientations of long axes, which is then etched to define said at least one magneto-resistive sensing element.

33. The integrated angular magnetic sensor apparatus of claim 32 wherein the at least one magneto-resistive sensing element has local magnetic fields applied to said at least one magneto-resistive sensing element, which is then thermally annealed to obtain exchange pinning on reference layers with various predetermined directions for each of said giant-magneto-resistive stripes.

34. The integrated angular magnetic sensor apparatus of claim 33 wherein said local magnetic fields are shape anisotropy fields, stress-induced magnetostrictive anisotropy fields, local hard bias fields, or local flux concentrating fields by adjacent soft magnetic layers.

35. The integrated angular magnetic sensor apparatus of claim 26 wherein the at least one magneto-resistive sensing element is a magnetic tunnel junction structure formed on said substrate.

36. The integrated angular magnetic sensor apparatus of claim 35 wherein the at least one magneto-resistive sensing element comprises:
a dielectric layer formed upon said substrate.
an anti-ferromagnetic layer deposited upon said dielectric layer;
a synthetic pinned layer deposited upon said anti-ferromagnetic layer;
a tunneling layer deposited upon said synthetic pinned layer; and
a free layer deposited upon said conductive layer.

37. The integrated angular magnetic sensor apparatus of claim 36 wherein said synthetic pinned layer comprises:
a first anti-parallel structure deposited upon said anti-ferromagnetic layer;
a nonmagnetic space layer deposited upon said first anti-parallel structure; and
a second anti-parallel structure deposited upon said nonmagnetic space layer.

38. The integrated angular magnetic sensor apparatus of claim 35 wherein the at least one magneto-resistive sensing element is patterned by a photo-mask into large rectangle-shaped giant-magneto-resistive stripes with a large aspect ratio and different orientations of long axes, where the large rectangle-shaped giant-magneto-resistive stripes are etched to define said at least one magneto-resistive sensing element.

39. The integrated angular magnetic sensor apparatus of claim 38 wherein the at least one magneto-resistive sensing element has local magnetic fields applied to said at least one magneto-resistive sensing element, which is then thermally annealed to obtain exchange pinning on reference layers with various predetermined directions for each of said giant-magneto-resistive stripes.

40. The integrated angular magnetic sensor apparatus of claim 49 wherein said local magnetic fields are shape anisotropy fields, stress-induced magnetostrictive anisotropy fields, local hard bias fields, or local flux concentrating fields by adjacent soft magnetic layers.

41. The integrated angular magnetic sensor apparatus of claim 26 wherein said magnetic field angle calculator circuit is connected to provide biasing voltages to said two anisotropic magneto-resistive sensing elements and said at least one magneto-resistive sensing element, and connected to receive a first output voltage and a second output voltage from said two anisotropic magneto-resistive sensing elements and at least a third output voltage from said at least one magneto-resistive sensing elements to determine a field angle of a magnetic field impinging upon said angular magnetic sensor.
